(19) United States
(12) Patent Application Publication
(10) Pub. No.: US 2015/0142884 A1
(43) Pub. Date: May 21, 2015

(54) Image Sharing for Online Collaborations

(71) Applicant: Microsoft Corporation, Redmond, WA (US)

(72) Inventor: Pablo Steven Veramendi, Chicago, IL (US)

(73) Assignee: Microsoft Corporation, Redmond, WA (US)

(21) Appl. No.: 14/086,391

(22) Filed: Nov. 21, 2013

(51) Int. Cl. H04L 12/18

(52) U.S. Cl. CPC H04L 12/1813
USPC 709/204

(57) ABSTRACT

Image sharing techniques for online collaborations are described in which images for sharing in a communication session may be processed to form image packages that are optimized for collaboration. An image package may be formed for a selected image that includes multiple versions of the image at different resolutions. In addition, the versions of the image at different resolutions may be divided into tiles that represent portions of the image at a corresponding resolution. As viewers navigate a viewing pane to pan and zoom within an image, the images at different resolutions and the tiles are selectively provided to enable fast rendering of different selected portions of the images. The image may be manipulated via a shared viewing pane that is accessible to multiple clients in a communication session for collaborative viewing of the image.

### BACKGROUND

User are increasingly relying upon cloud-based resources for conducting business and personal communications including online meetings, screen-sharing, video chats, messaging, and otherwise using various resources available from service providers. For example, users may collaborate in an online meeting session. Using traditional techniques, sharing very high resolution images, such as medical images and raw format photographs, may be difficult during an online collaboration because of latency associated with transmitting large amounts of data associated with high resolution images. Existing techniques may rely upon communication of a full image to each client in a session, which may not be practical for very large images and/or may exceed bandwidth restrictions in some scenarios. Using a lower resolution version of the image may be an alternative, however this approach obscures image details that may be crucial for medical evaluations, graphic designs, and other collaborations. Accordingly, existing image sharing techniques may not be suitable in some settings and use scenarios.

### SUMMARY

Image sharing techniques for online collaboration are described in which images for sharing in a communication session may be processed to form image packages that are optimized for collaboration. In particular, an image package may be formed for a selected image that includes multiple versions of the image at different resolutions. In addition, the versions of the image at different resolutions may be further divided into a plurality of tiles that represent portions of the image at a corresponding resolution. As a viewer navigates a viewing pane to pan and zoom within an image, the images at different resolutions and the plurality of tiles may be selectively provided to enable fast rendering of different selected portions of the image. A hierarchy of resolutions and tiles in the image package may be employed and blended together as users navigate the image to represent smooth transitions between different zoom levels and selected portions of the image. The image may be manipulated via a shared viewing pane that is accessible to multiple clients via a communication session for collaborative viewing of the image. In an implementation, the viewing pane may be controllable by both a presenter and other viewers in the communication session to manipulate the image in various ways.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the following discussion.

FIG. 1 is an illustration of an example operating environment that is operable to employ techniques for image sharing in connection with online collaborations.

FIG. 2 is a diagram depicting some details of an example image package in accordance with one or more implementations.

FIG. 3 is a diagram depicting a representation of using a viewing pane to manipulate a shared view of an image in accordance with one or more implementations.

FIG. 4 is a flow diagram depicting an example procedure to share an image during a communication session in accordance with one or more implementations.

FIG. 5 is a flow diagram depicting an example procedure to pre-process an image to create an image package in accordance with one or more implementations.

FIG. 6 is a flow diagram depicting an example procedure to manipulate an image via a viewing pane during an online communication session in accordance with one or more implementations.

FIG. 7 illustrates an example system having devices and components that may be employed to implement aspects of the techniques described herein.

### DETAILED DESCRIPTION

### Overview

Traditional techniques for sharing images may be unsuitable for sharing very high resolution images in an online meeting scenario because of latency associated with transmitting large amounts of data associated with high resolution images. Such existing techniques may rely upon communication of a full image to each client in a session, which may not be practical for very large images and/or may exceed bandwidth restrictions.

Image sharing techniques for online collaborations are described in which images for sharing in a communication session may be processed to form image packages that are optimized for collaboration. In particular, an image package may be formed for a selected image that includes multiple versions of the image at different resolutions. In addition, the versions of the image at different resolutions may be further divided into a plurality of tiles that represent portions of the image at a corresponding resolution. As a viewer navigates a viewing pane to pan and zoom within an image, the images at different resolutions and the plurality of tiles may be selectively provided to enable fast rendering of different selected portions of the image. A hierarchy of resolutions and tiles in the image package may be employed and blended together as users navigate the image to represent smooth transitions between different zoom levels and selected portions of the image. The image may be manipulated via a shared viewing pane that is accessible to multiple clients via a communication session for collaborative viewing of the image. In an implementation, the viewing pane may be controllable by both a presenter and other viewers in the communication session to manipulate the image in various ways. The use of image packages as discussed herein may enable efficient sharing and fast navigation of images including images having very large resolutions during communication sessions in manner that is not attainable with traditional techniques.

In the following discussion, an example environment is first described that may employ the techniques described herein. Example details and procedures are then described which may be implemented in the example environment as well as other environments. Consequently, the example details and procedures are not limited to the example environment and the example environment is not limited to the example details and procedures. Lastly, an example system and components of the system are discussed that may be employed to implement aspects of the techniques described herein.

Example Environment

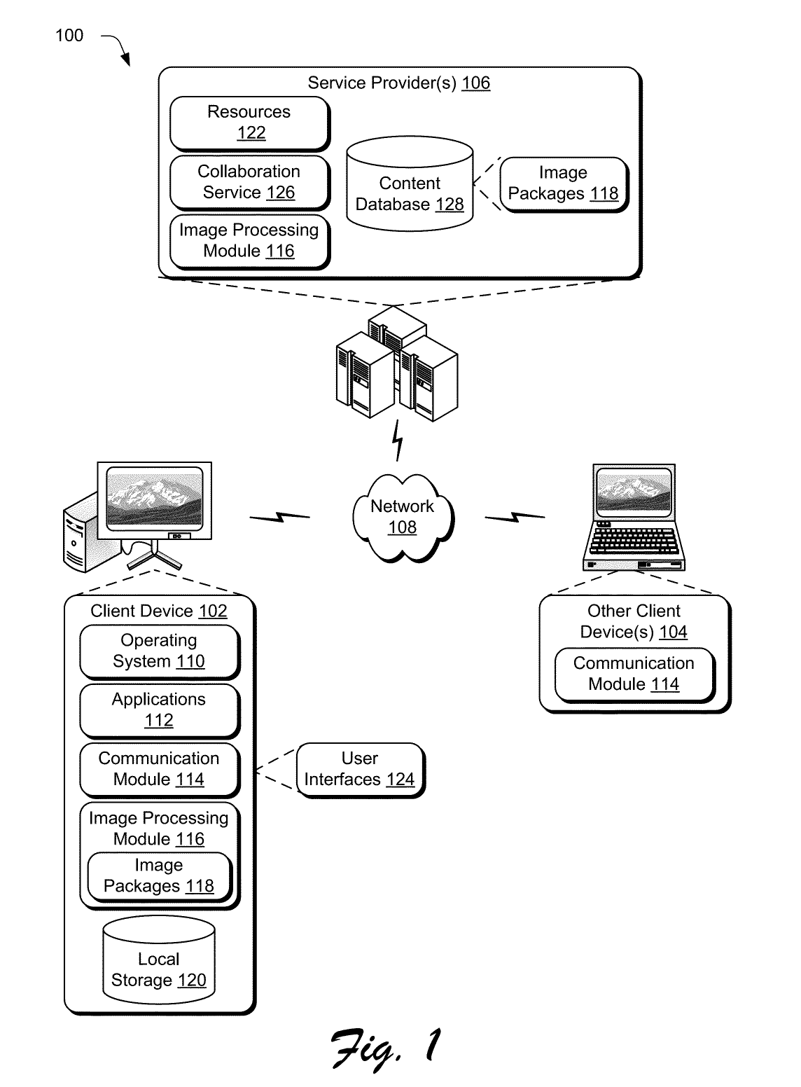

FIG. 1 is an illustration of an environment 100 in an example implementation that is operable to employ techniques described herein. The illustrated environment 100 includes a client device 102, an other client device 104, and a service provider 106 that are communicatively coupled via a network 108. The client device 102, other client device 104, and service provider 106 may be implemented by one or more computing devices and also may be representative of one or more entities.

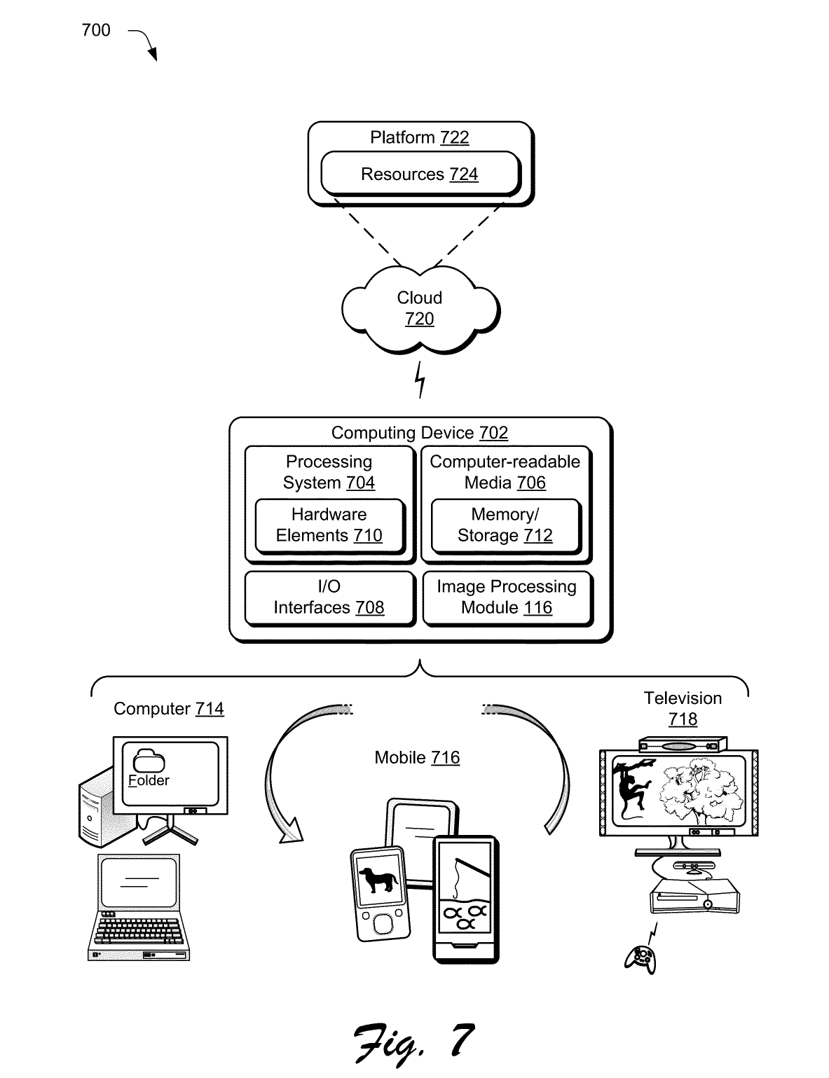

A computing device may be configured in a variety of ways. For example, a computing device may be configured as a computer that is capable of communicating over the network 108, such as a desktop computer, a mobile station, an entertainment appliance, a set-top box communicatively coupled to a display device, a wireless phone, a game console, and so forth. Thus, the computing device may range from full resource devices with substantial memory and processor resources (e.g., personal computers, game consoles) to a low-resource device with limited memory and/or processing resources (e.g., traditional set-top boxes, hand-held game consoles). Additionally, although a single computing device is shown in some instances, the computing device may be representative of a plurality of different devices, such as multiple servers of the service provider 106 utilized by a business to perform operations, and so on. Further examples of computing systems and devices suitable to implement techniques described herein are described below in relation to FIG. 7.

Although the network 108 is illustrated as the Internet, the network may assume a wide variety of configurations. For example, the network 108 may include a wide area network (WAN), a local area network (LAN), a wireless network, a public telephone network, an intranet, a peer-to-peer network, and so on. Further, although a single network 108 is shown, the network 108 may be configured to include multiple networks.

The client device 102 is further illustrated as including an operating system 110. The operating system 110 is configured to abstract underlying functionality of the underlying device to applications 112 that are executable on the client device 102. For example, the operating system 110 may abstract processing, memory, network, and/or display functionality such that the applications 112 may be written without knowing “how” this underlying functionality is implemented. The application 112, for instance, may provide data to the operating system 110 to be rendered and displayed by a display device as illustrated without understanding how this rendering will be performed. A variety of applications 112 typically associated with client devices are contemplated including, but not limited to, a productivity suite that integrates multiple office productivity modules, a web browser, games, a multi-media player, a word processor, a spreadsheet program, a photo manager, and so forth.

The client device 102 and other client device are each illustrated as including a communication module 114. The communication modules are representative of functionality to enable various kinds of communications via the network 108. Examples of the communication modules include a voice communication application (e.g., a VoIP client), a video communication application, a messaging application, a content sharing application, a browser to access web content and combinations thereof. The communication module 114 for instance, enables different communication modalities to be combined to provide diverse communication scenarios. This includes but is not limited to implementing integrated functionality for user presence indications, video communications, online collaboration and meeting experiences, instant messaging (IM), and voice calling. Further, the communication module may be operable to access online resources (e.g., content and services), browse web pages and sites, establish communication connections with service providers and other clients, and so forth. In at least some implementations, the communication module 114 represents an application that is deployed to and installed locally on a client device. Additionally or alternatively, the communication module 114 may be implemented all or in part as a remote application that is accessed and executed via a web browser (e.g., a web application), as a remote service from a provider, using peer-to-peer techniques, and so forth.

Additionally, the client device 102 may include an image processing module 116 configured to implement techniques for image sharing in connection with online collaborations as described herein. As illustrated, the image processing module 116 may be provided as a standalone module that various applications 112 may make use of to form image packages 118 as described herein. In addition or alternatively, the image processing module 116 may be implemented as a component of another application, such as being an integrated component of the communication module 114.

The image processing module 116 may be configured to produce and make use of image packages 118 that are designed to facilitate collaborative sharing of images and fast navigation of images during a communication session between clients. Effectively, the image package 118 is configured to contain a collection of sub-images that correspond to a full resolution image that are usable to form different views of the full resolution image. The collection may include a plurality of versions of the image having different resolutions. Additionally, the plurality of versions of the image may each be further divided into one or more smaller sized tiles. Thus, an image package 118 for a particular image may be arranged as a hierarchy of sub-images at different resolutions and a plurality of corresponding tiles that may be selectively invoked to show different views of the particular image at varying levels of detail. For instance, the image package 118 may be logically represented as a hierarchical pyramid of resolutions for a corresponding image that are divided into respective tiles (e.g., sub-images) between a very low resolution version (e.g., a 1×1 pixel resolution version of the image) and the full-resolution version of the corresponding image.

In order to share an image during a communication session, the resolution versions and tiles contained in an image package 118 may be selectively employed to render a selected view of the image at a selected location and zoom level. Rather than loading the entire full resolution image all at once, a few of the tiles that match a selected view may be identified, communicated to clients in the communication session, and/or rendered by the clients to quickly present the selected view of the image. Then, additional tiles and/or higher resolution versions of the image may be obtained and used to sharpen the image and/or show greater detail over time. In other words, a relatively low resolution version of an image may initially be loaded and then higher resolution version may be blended in as they become available.

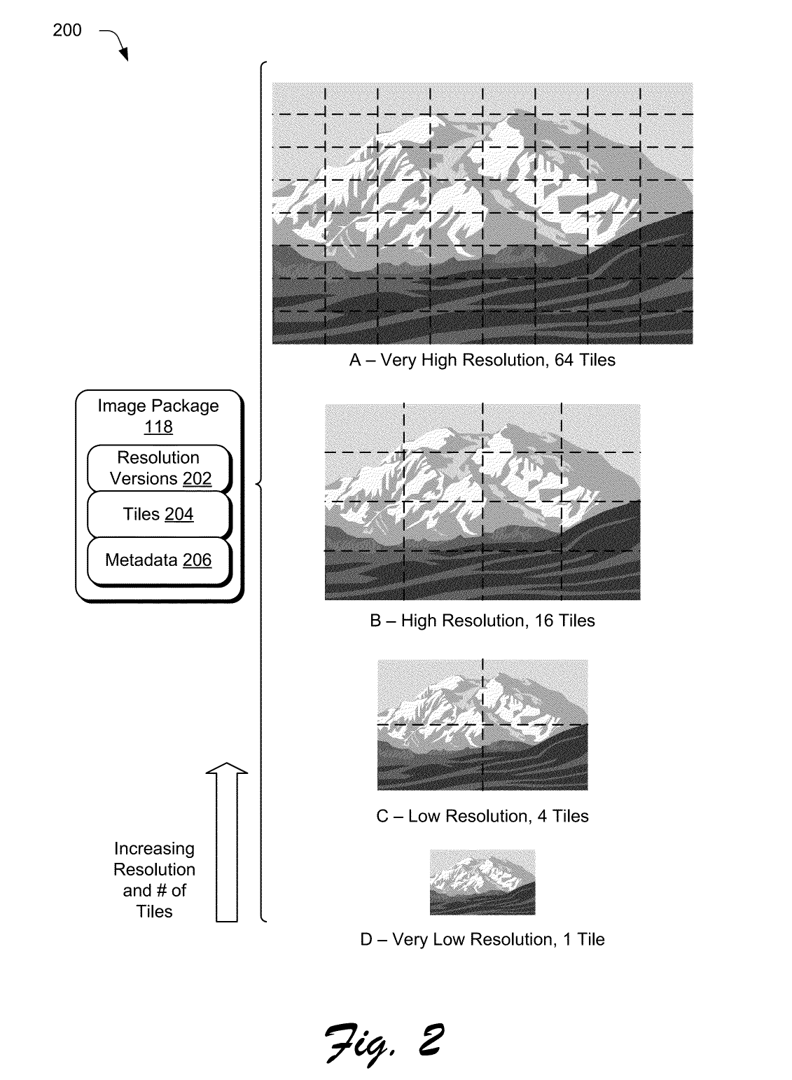

Likewise, the resolution versions and tiles contained in an image package 118 are employed to provide a comparable experience as users interact to manipulate the image, such as by zooming and panning to expose a view of the image via a user interface at a selected location and zoom level. Manipulation of an image by a presenter as well as by other viewers may occur via a shared view of the image that is presented in connection with a collaboration session between multiple clients. For instance, when a user zooms into an image, tiles matching the portion of the image on which the zoom is focused may be obtained/rendered quickly to show a view of the portion of the image at the highest available resolution. Just the appropriate tiles corresponding to the portion of the image are loaded and accordingly the zoomed view can be displayed without having to load the entire image at the highest available resolution. Further details regarding the configuration and use of image packages 118 are discussed in relation to FIG. 2 below.

As further shown if FIG. 1, the client device 102 may include local storage 120 in which various content may be stored, including but not limited to image packages 118, image files, slides, presentations, shared files, and other types of content that may be used in a collaboration session. Other items of content for a presentation or collaboration session may be uploaded to and/or available from remote sources, such as the service provider 106, a particular web site, another client, and so forth. Thus, a particular collaboration session may employ a combination of various items of content including combinations of local and remote content with respect to the particular client device.

The service provider 106 includes functionality operable to manage various resources 122 that may be made available over the network 108. For example, service provider 106 may provide various resources 122 via webpages or other user interfaces 124 that are communicated over the network for output by one or more clients via a web browser or other client application. The service provider 106 is configured to manage access to the resources 122, performance of the resources, and configuration of user interfaces 124 to provide the resources 122, and so on. The service provider 106 may represent one or more server devices used to provide the various resources 122.

Generally, resources 122 made accessible by a service provider 106 may include any suitable combination of services and/or content typically made available over a network by one or more providers. Some examples of services include, but are not limited to, a search service, an email service, an instant messaging service, an online productivity suite, and an authentication service to control access of clients to the resources 122. Content may include various combinations of text, multi-media streams, documents, application files, photos, audio/video files animations, images, web pages, web applications, device applications, content for display by a browser or other client application, and the like.

One particular example of a resource 122 that may be accessible via the service provider is a collaboration service 126 as represented in FIG. 1. The collaboration service 126 is representative of a service to perform various tasks for management of communications between the client device 102 and other client device 104. The collaboration service 126, for instance, may be operable to manage initiation, moderation, and termination of communication sessions for the clients. The communication service 126 may integrate functionality for one or more of VoIP calls, online meeting and conferencing, screen sharing, a unified communications and collaboration (UC&C) service, instant messaging, video chats, and so forth. The communication service 126 may also be implemented as or be connected to a private branch exchange (PBX) in communication with a Public Switched Telephone Network (“PSTN”) to enable voice communication between the client terminal and other devices. The collaboration service 126 also represents functionality to implement aspects of techniques for image sharing during online collaborations as discussed above and below.

In an implementation, the communication service 126 may also configured to provide an image processing module 116 that may be accessed over the network 108 for execution to create image packages 118. Here, the image processing module 116 may be a module that is exposed for download and execution locally at the clients. The image processing module 116 may alternatively be configured as a cloud-based service or a web application that is operable via a web browser or other client application corresponding to the web application that is deployed to the clients. Thus, functionality described herein in relation to the image processing module 116 may be made available locally at a client device, over the network 108 from the service provider 106, or in both of these ways.

The service provider 106 is additionally depicted as having a content database 128 that may be configured to store various content in addition to or in lieu of storing the content in local storage 120. Image packages 118 in the content database 128 are representative of content available from a remote location/source that may be associated with a collaboration session. Naturally, additional sources such as third party providers, other clients, and other web-accessible sites and locations may also maintain image packages 118 that may be employed during a session.

The content database 128 also represents an online repository for image packages 118. For example, image packages 118 may be uploaded via the collaboration service 126 to enable access during a communication session. The collaboration service 126 may then operate to stream images and/or tiles contained in the image packages 118 to various viewing devices (e.g., clients) and/or enable downloading from the content database 128. The images may be streamed to multiple viewers/clients/devices substantially simultaneously as part of an online meeting and collaboration session, on-demand to individual viewers, at the direction of a presenter, and so forth.

In at least some embodiments, clients may access the collaboration service 126 and other resources 122 provided by a service provider 106 through client/user accounts to which the clients are authenticated. For instance, to access resources 122, a client device may provide a username and password that are authenticated by an authentication service. When the authentication is successful (e.g., the client “is who they say they are”), the authentication service may pass a token (or other suitable authentication identifier/secret) to enable access to corresponding resources. A single authentication may correspond to one or more resources, such that authentication to a single account by a “single sign-on” may provide access to individual resources, resources from multiple service providers 106, and/or to an entire suite of resources available from a service provider 106.

To further illustrate, consider now FIG. 2, which depicts a diagram depicting some details of an example image package in accordance with one or more implementations a diagram depicting some details of an example image package in accordance with one or more implementations, generally at 200. In particular, an example representation of an image package 118 is depicted that includes resolution versions 202, tiles 204, and metadata 206 for a corresponding image. The image package 118 may be constructed through operation of the image processing module 116 upon an input image. Generally, the input image is an image that a presenter/owner intends to share during a collaboration session. For images having very high resolution, the presenter may choose to invoke the image processing module 116 to pre-process the image to facilitate sharing. Pre-processing of the image may create an image package 118 that is optimized for sharing during an online collaboration. In an implementation, the image processing module 116 may be accessible via a communication module 114 or other application 112 that is configured to support various online collaborations. Construction of the image package 118 may occur locally at a client and/or through interaction with a collaboration service 126 over a network 108. The image package 118 may then be accessed from local storage 120, a content database 128, or other network accessible storage location during an online collaboration session to share a corresponding image.

The resolution versions 202 represent different pre-computed versions of the base image having varying resolutions. The resolution versions 202 may be constructed as a group of texture maps that correspond to different representations of the image. For sharing of the image during a communication session, appropriate texture maps at an appropriate resolution are used for rendering of a current frame as a representation of the image is being manipulated to show different views. The construction of pre-computed versions is analogous to mipmapping techniques employed for 3D graphics rendering techniques in which collections of images to accompany a main texture are generated to increase rendering speed and reduce aliasing artifacts.

For example, a series of versions of an image between the full resolution of the input image and a designated low level resolution may be constructed for the image package 118. The resolutions selected for image packages may range from a 1×1 pixel representation at the low end up to the native resolution of the input image at the high end. In general, any number of resolution versions 202 having different resolutions may be included in a package and different packages may be constructed with different numbers of resolution versions 202. Practically speaking, the number of resolution versions 202 employed may be constrained by and/or selected according to an upper bound placed on the size of the image package, available storage capacity for images, the native resolution of the input image, performance metrics to balance image quality versus resource utilization, and other factors.

Additionally, the tiles 204 represent divisions of the image into sub-images that may be made to the resolution versions 204 at each level. Tiles 204 may be produced according to a designated tile size. The tile size may be predefined by the system and/or may be configurable by a user. In one approach, the tile size may be selected based upon the full resolution of the base image, such as a tile size that is a fraction of the full resolution (e.g., ¼, ⅛, 1/16, 1/32, etc.). In addition or alternatively, a fixed tile size (e.g., 256×256, 128×128, 64×64) may be specified based upon factors including but not limited to network bandwidth, processing power, available memory, display device resolution/capabilities, and so forth.

For resolution versions 202 constructed for an image package that are greater than the tile size, these versions are broken up into multiple tiles 204. In an implementation, tiles for a given resolution version 202 may be configured to overlap one to another on the borders between tiles by one or more pixels to facilitate seamless stitching together of tiles at the borders without artifacts when rendering a view. If one or more resolution versions 204 for an image package are equal to or smaller than the designated tile size, these versions may be stored “as is” as a single image/texture (e.g., a single tile).

A variety of metadata 206 may also be incorporated in the image package 118. The metadata 206 provide a mechanism to convey information regarding the arrangement of the image package 118 to the collaboration service and/or a client rendering application. The metadata 206 may be employed to identify, retrieve, and/or deliver appropriate versions and tiles to use for different views at selected location and zoom levels. For example, the metadata 206 may describe the arrangement of the image package 118 and the collection of sub-images (e.g., resolution versions 202 and tiles 204) corresponding to the image contained in the package. The description may include at least the size and number of resolution versions, the tile size, and number of tiles included for each version. The metadata 206 may also describe one or more of a mapping of tiles to image locations for use to navigate the tiles, zoom level and/or depth level data, an indication of the amount of tile overlap, a logical hierarchy that associates the versions and tiles at different levels using corresponding identifiers, image format data, and so forth. Given input to specify a view of the image, the metadata 206 may be referenced to recognize resolution versions 202 and tiles 204 that correspond to the view. The appropriate resolution versions 202 and tiles 204 may then be used to render the portion of the image at a location visible within a viewing pane at the selected zoom level. In the case of very high resolution images, the display resolution is typically less than the full image resolution and thus a selected view may be rendered using just a few tiles, which may significantly reduce the amount of data to load/render relative to loading of the full image all at once. This approach makes real-time sharing of very high resolution images viable during online collaborations.

By way of example, FIG. 2 represents the example image package 118 as including four different resolution versions 202, which are labeled with letters A-D. Naturally, greater or fewer versions may be employed in other instances and implementations. Image A is representative of a very high resolution image that corresponds to the original image selected for sharing. Images B-D represent resolution versions 202 having resolutions that are less than the full resolution and are constructed from the original image for inclusion in the image package. In particular, image B is a high resolution image, image C is a low resolution, and image D is a very low resolution image.

Additionally, FIG. 2 illustrates division of the example images A-D into corresponding tiles 204 in the manner described herein. Here, the tiles are generated based upon a designated tile size as described previously. For instance, the images A-D in the depicted example may correspond to image sizes of 2056×2056, 1024×1024, 512×512, and 256×256 pixels respectively. A tile size of 256×256 may be specified as a pre-defined value, a user selection, or otherwise. Accordingly, the images A-D are shown as being divided into respective numbers of tiles based on the tile size of 256×256. In particular, images A-D are depicted as being broken into 64 tiles, 16 tiles, 4 tiles and 1 tile with the tile size of 256×256, respectively. A variety of other examples having different tile sizes, resolutions, and numbers of image versions are contemplated.

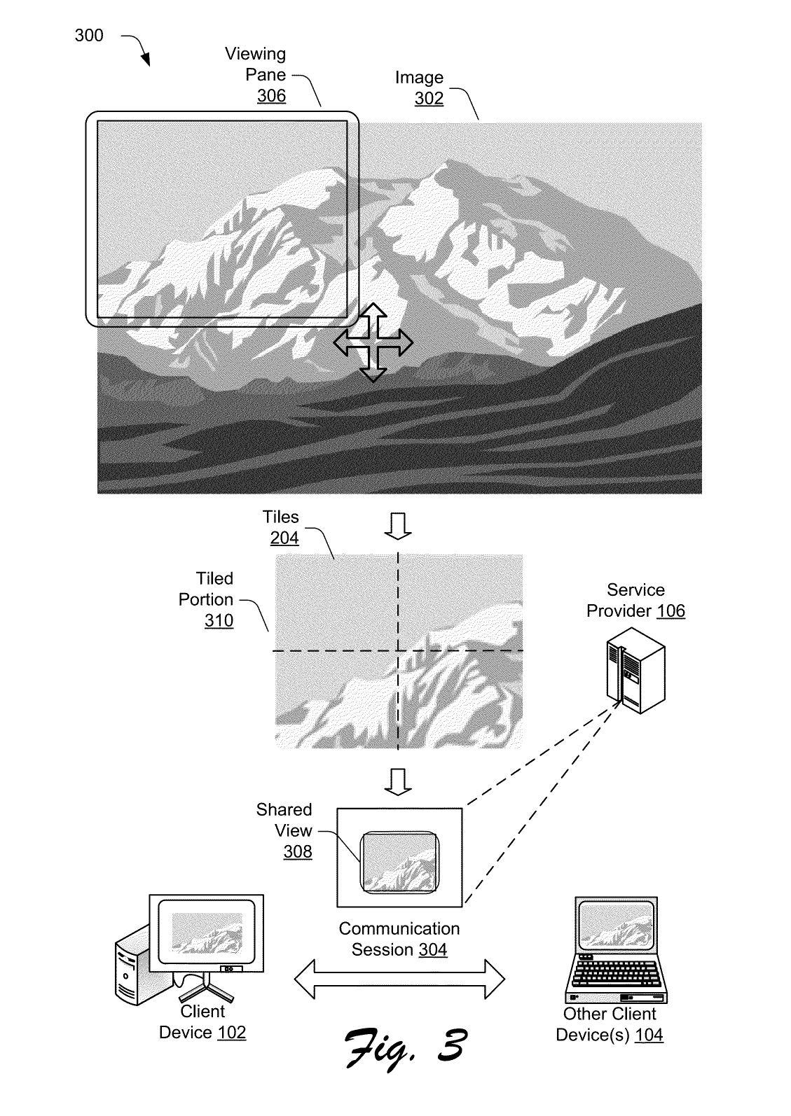

FIG. 3 shows a diagram depicting a representation of using a viewing pane to manipulate a shared view of an image in accordance with one or more implementations, generally at 300. Here, an image 302 is represented that corresponds to an image being shared during a communication session between clients, such as the communication session 304 established between the client device 102 and other client device 104 depicted in FIG. 3.

The communication session 304 may be implemented via a collaboration service 126 that facilitates the session via client software such as communication modules 114 or other suitable applications 112 associated with each device. Alternatively, the communication session 304 may be established as a peer-to-peer session between multiple clients using peer-to-peer functionality without necessarily relying upon a separate collaboration service 126. A user interface 124 presented via the communication modules 114 in connection with the communication session 304 may provide a viewing pane 306 that enables manipulation of the image 302 to present different views. In particular, the viewing pane 306 is configured to enable selection of a portion of the image 302 to present in a shared view 308 that is accessible to the clients involved in the communication session 304. Each of the clients may render the shared view 308 for display via respective display devices, such as within an application window exposed by the communication modules that is configured to show the portion of the image 302 within the viewing pane 306.

The viewing pane 306 may be configured to enable panning to select different locations within the image and zooming in or out to different zoom levels to show different views. The viewing pane 306 and accordingly the shared view 308 may be manipulable by a presenter and/or by other viewers involved in the collaboration. For example, control data generated in response to user input at one of the clients may be received and interpreted by a collaboration service 126 or one of the communication modules 114. The control data may indicate manipulation of the viewing pane 306 to cause at least a portion of the image to be displayed in the shared view 308.

In response to receiving the control data, one or more tiles 204 corresponding to the view of the image may be identified (using metadata 206 or otherwise). In other words, tiles that match a selected view of the image may be identified and output for rendering by multiple clients substantially at the same time. This provides a mechanism to implement the shared view of the image during the communication session, such that viewers associated with different clients/devices each see the same view of an image and may interact collaboratively with the shared view.

As represented in FIG. 3, the tiles that are identified may form a tiled portion 310 that corresponds to the selected view. Accordingly, the identified tiles that make up the tiled portion 310 may be communicated for display via the multiple clients in the shared view 308.

In one approach, the identified tiles are output by a service provider 106 via a collaboration service 126 for rendering by the clients. Alternatively, a client device associated with a presenter of the image may process the control data to determine a selected view, identify tiles corresponding to the selected view, and communicate the tiles to one or more other client devices associated with other participants in the communication session 304. The image data may be incorporated into web documents, such as mark-up language pages, image files (e.g., RAW, JPEG, TIFF, GIF, BMP, etc), or other pages/files in an appropriate format that is supported by the communication modules 114. Thus, communication of tiles may involve communication of web documents that incorporate the tiles in an appropriate format.

Having considered the foregoing example environment and details, consider now a discussion of some further details of image-sharing for online collaborations in relation to the following example procedures.

Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference may be made to the environment 100 of FIG. 1 and the examples of FIGS. 2 and 3. For instance, aspects of the procedures may be performed by a suitably configured computing device, such as a client device that includes or otherwise makes use of a communication module 114 and/or an image processing module 116. Aspects of the procedures may also be performed by one or more server devices, such as a servers associated with a service provider 106 configured to provide a collaboration service 126.

Functionality, features, and concepts described in relation to the examples of FIGS. 1-3 may be employed in the context of the procedures described herein. Further, functionality, features, and concepts described in relation to different procedures below may be interchanged among the different procedures and are not limited to implementation in the context of an individual procedure. Moreover, blocks associated with different representative procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples.

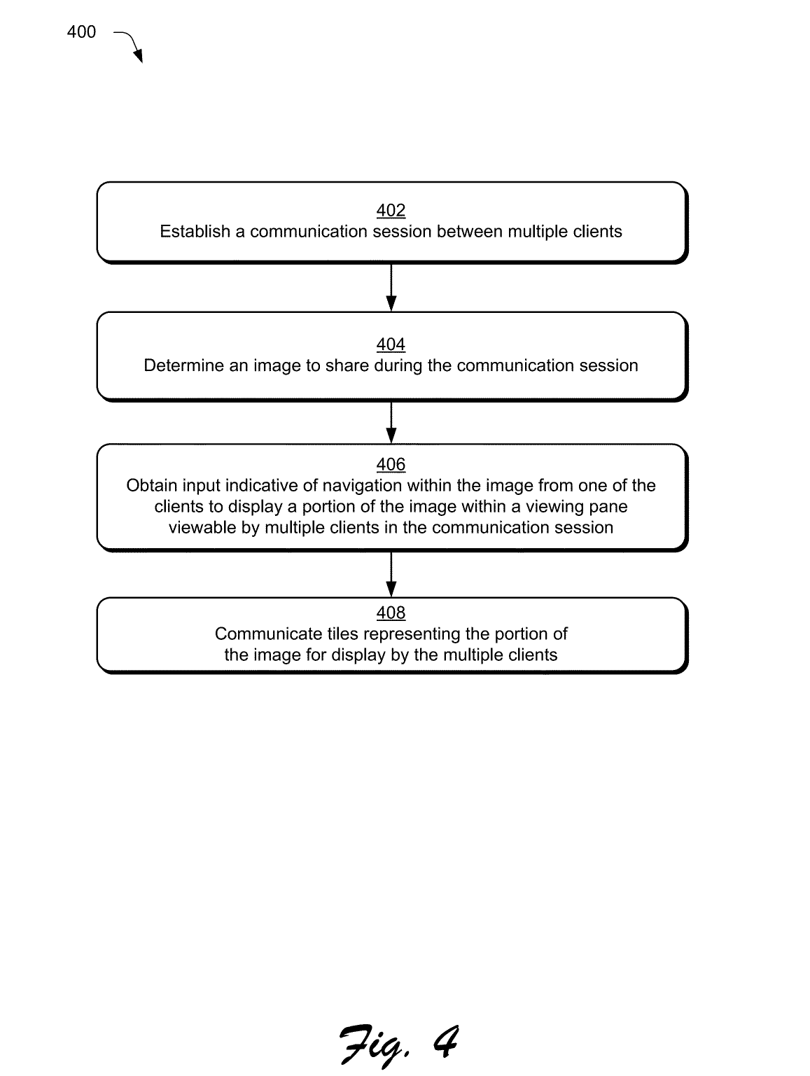

FIG. 4 is a flow diagram depicting an example procedure 400 to share an image during a communication session in accordance with one or more implementations. A communication session is established between clients (block 402). A communication session 304 between multiple clients may be established in various ways using various applications. For instance, a communication module 114 that supports online collaboration may be employed to initiate a communication session 302 via a collaboration service 126. The communication session may also be a peer-to-peer session. Further, the communication session may support image sharing between clients in a shared view 308 in the manner described above and below.

An image to share during the communication session is determined (block 404). The image for sharing may be selected by a user in any suitable way. One way this may occur is via a user interface or dialog that is provided via a communication module 114. In an implementation, visual representations of available images may be presented via the user interface. Images may be captured from an image capture device, obtained from various computer-readable media, downloaded over a network, and so forth. Responsive to selection of an image, an option to form an image package 118 for sharing the image may be triggered. Formation of an image package 118 may also be triggered in other ways, such as via a menu item, a tool bar, or other user interface instrumentalities. In an implementation, the option to form an image package is triggered based upon the resolution of the selected image. If the resolution of the image is over a threshold resolution, then pre-processing into an image package may be triggered. Otherwise, an image having less than the threshold resolution may be shared directly without pre-processing into an image package. Selection of the option when available may invoke an image processing module 116 to pre-process the image to form a corresponding image package as discussed herein.

In another example, a selected image may have been previously configured into an image package 118 and stored for subsequent use. For example, an existing image package 118 may be selected from local storage 120, a content database 128, or other suitable storage location. The image package 118 may already be arranged in an appropriate state for sharing during the communication session. Accordingly, the image represented by the image package 118 may be shared without further processing to create different resolution versions and/or tiles.

In any event, the image package 118 may be employed to share the corresponding image in the communication session. For instance, a shared view 308 of the image may be output for display via multiple clients as discussed previously. This may involve configuration of a user interface 124 to present the shared view 308. The shared view may be exposed based upon logical positioning of a viewing pane 306 to show at least a portion of an image 302. For instance, the user interface 124 and/or data sufficient to form the user interface with a selected view of the image may be generated and distributed to various clients through the collaboration service 126. In addition or alternatively, a communication module 114 of a client device 102 may be configured to generate the shared view locally and distribute data sufficient to form the view to multiple clients over a network, thereby enabling rendering of the view by individual clients in the communication session. When performed by a client, distribution and/or generation of the data sufficient to form the view may occur in various ways. For example, the client may interact with and/or direct a collaboration service 126 to produce the shared view. Alternatively, the communication module 114 may be operable to form the data and supply the data directly to other clients in a peer-to-peer approach.

In this manner, a shared view of an image may be exposed to multiple clients in a communication session. The clients may be able to collaborate in various ways to view the image, navigate to expose various portion of the image, zoom in and/out, position the viewing pane, annotate the image, and/or otherwise interact with the shared view during the session. As one or more of the clients provide input to manipulate the image through the user interface 126, different resolution versions of the image and corresponding tiles may be selectively retrieved and used to render corresponding views. The tiles used for different individual views collectively have less data than the image data for the full image at the original resolution, which significantly reduces the amount of data to load/render each individual view. Different views may therefore be generated using less computing resources (e.g., processing power and memory) and displayed quickly.

In particular, input indicative of navigation within the image is obtained from one of the clients to display a portion of the image within a viewing pane viewable by multiple clients in the communication session (block 406) and tiles representing a the portion of the image are communicated for display by the multiple clients (block 408). Input to manipulate a view of an image during a communication session may be obtained in various ways. For example, input may be provided to position a viewing pane as discussed in relation to FIG. 3. This may include at least input to cause panning to select different locations within the image and zooming in or out to different zoom levels. The input may be provided via client devices associated with a presenter and/or via other client devices associated with viewers involved in the collaboration. In response to the input, control data may be generated and communicated to cause corresponding modifications of the view. The control data for instance may indicate manipulation of the viewing pane 306 to cause at least a portion of the image to be displayed in a shared view 308.

In various implementations, the control data may be received and interpreted by a collaboration service 126 and/or the communication modules 114 of one or more clients to ascertain a particular view (e.g., location and zoom level) of the image reflected by the control data. Additionally, tiles 204 sufficient to render the particular view of the image may be identified based on the control data and communicated to enable display of the portion of the image by clients in the communication session. Identification of appropriate tiles 204 may involve selecting the tiles from an image package 118. In one approach, metadata 206 associated with the image package 118 may be referenced to recognize resolution versions 202 and tiles 204 that correspond to the currently selected view. Alternatively, tiles/image packages may be generated on-demand responsive to obtaining input to manipulate the view. Thus, the identification of tiles may include generating at least some tiles for particular view on-demand during the communication session. For example, an image processing module 116 may be invoked to form tiles/image packages on-demand during the communication session in instances in which an image package 118 for a shared image is not produced in advance or cannot be found.

In each of the approaches, appropriate resolution versions 202 and/or tiles 204 are identified that match a particular view of the image reflected by input obtained to manipulate the view and/or corresponding control data. Identified resolution versions 202 and/or tiles 204 may then be employed to render the selected portion of the image in a shared view as described herein. For instance, selected tiles 204 sufficient to form the view may be communicated to one or more clients in the communication session to enable the clients to display the view. The shared view represents a portion of the image at a selected location and a selected zoom level. The selected tiles 204 to construct the view may be communicated from the collaboration service 126 for rendering by communication modules 114 associated with each of the clients. In addition or alternatively, selected tiles 204 may be communicated directly between communication modules 114 in a peer-to-peer session in some scenarios.

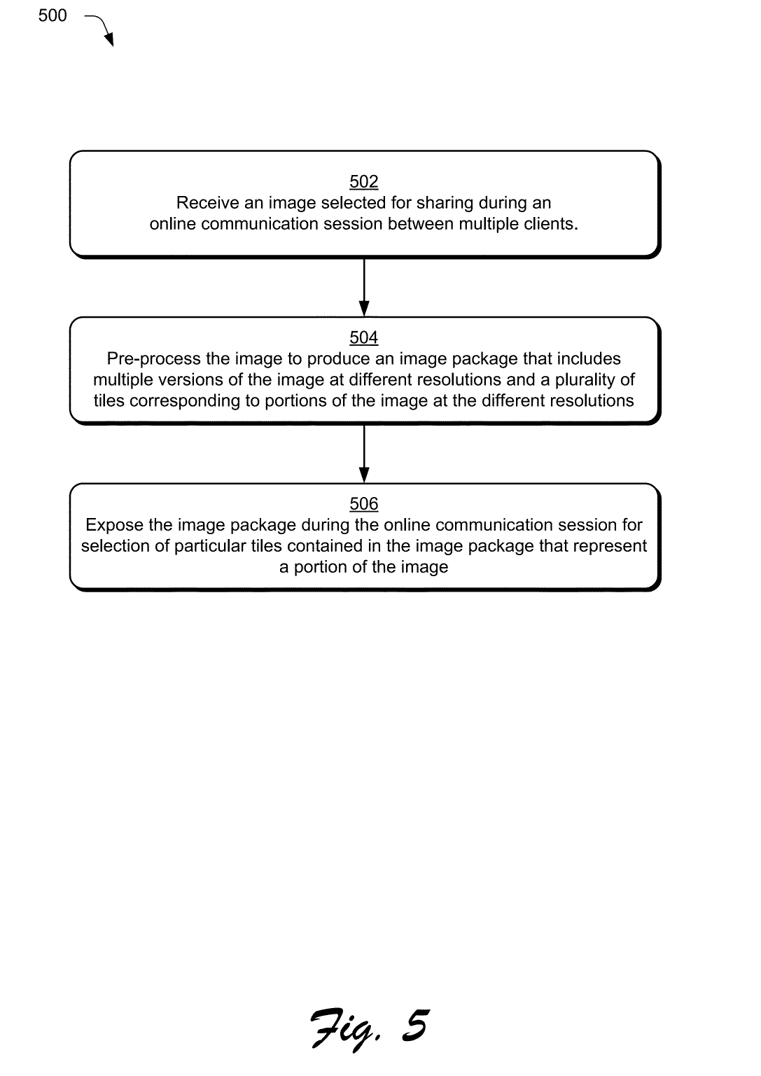

FIG. 5 is a flow diagram depicting an example procedure to pre-process an image to create an image package in accordance with one or more implementations. An image selected for sharing during an online communication session between multiple clients is received (block 502). For example, a presenter or other participant in a communication session may provide input to select an image to share in various ways described previously. The selection may occur via a suitable user interface 124 of a communication module 114 or other application configured to enable the selection via various menus, controls, tools and other user interface instrumentalities exposed in the interface.

The image is pre-processed to produce an image package that includes multiple versions of the image at different resolutions and a plurality of tiles corresponding to portions of the image data at the different resolutions (block 504). Here, an image processing module 116 or equivalent functionality may be invoked to create an image package 118. Operation of the image processing module 116 may be directed under the influence of the collaboration module 126 and/or a communication module 114 of a client. The image package 118 may be configured in various ways some examples of which are described in this document. As described in relation to FIG. 2, the image package 118 is generally configured to contain multiple resolution versions 202 of the image at different resolutions and a plurality of tiles 204 corresponding to portions of the image data at the different resolutions. Additionally, the image package 118 may contain metadata 206 that describes the contents of the packages and is usable to identify, retrieve, and/or deliver appropriate versions and tiles to use to output different views at selected location and zoom levels.

The image package is exposed during the online communication session for selection of particular tiles contained in the image package that represent a portion of the image (block 506). This may involve storing the image at a designated storage location accessible during the communication session to use the collection of sub-images contained in the image package. For example, an image package 118 for use during a session may be stored in and exposed via local storage 120 of a client or a content database 128 accessible via a service provider 106. The collaboration service 126 and/or communications modules 114 of clients may be configured to locate and access the image package 118 when a corresponding image is selected for sharing during the session and/or in response to navigation input to manipulate a view of the image. Contents of the image package 118 including resolution versions 202, tiles 204, and metadata 206 may be used to identify and selectively use different resolution versions 202 and/or tiles 204 to display a selected portion of the image at a selected zoom level.

In one approach, the collaboration service 126 may be configured to load an image package responsive to an initial selection to share the image. The collaboration service 126 may then supply different resolution versions 202 and/or tiles 204 from the package to clients in the communication session to enable formation of different views. As the clients navigate the shared view to interact with different portions of the image and zoom in and out, the collaboration service 126 may respond by selecting and supplying corresponding resolution versions 202 and/or tiles 204 to enable presentation of the different views. In addition or alternatively, functionality to identify and selectively use different versions/tiles available in an image package 118 may be implemented by a communication module 114 associated with one or more of the clients.

The resolution versions and tiles selected to supply to clients may depend upon the capabilities of each client including at least the display resolution and computing resources available to each client. In instances in which the capabilities of clients vary, the resolution versions and tiles supplied to clients having different capabilities may vary accordingly, such that different information may be supplied to different clients. In other instances, clients may have substantially similar capabilities and in this case the same information may be supplied to each client. In addition or alternatively, the collaboration service 126 may also be further configured to select a level of service to supply based on overall capabilities of the multiple clients in which case information that matches the selected level of service may be supplied to each of the clients so that the experience is common across the different devices involved in the collaboration (e.g., the viewers see substantially the same view of the shared image).

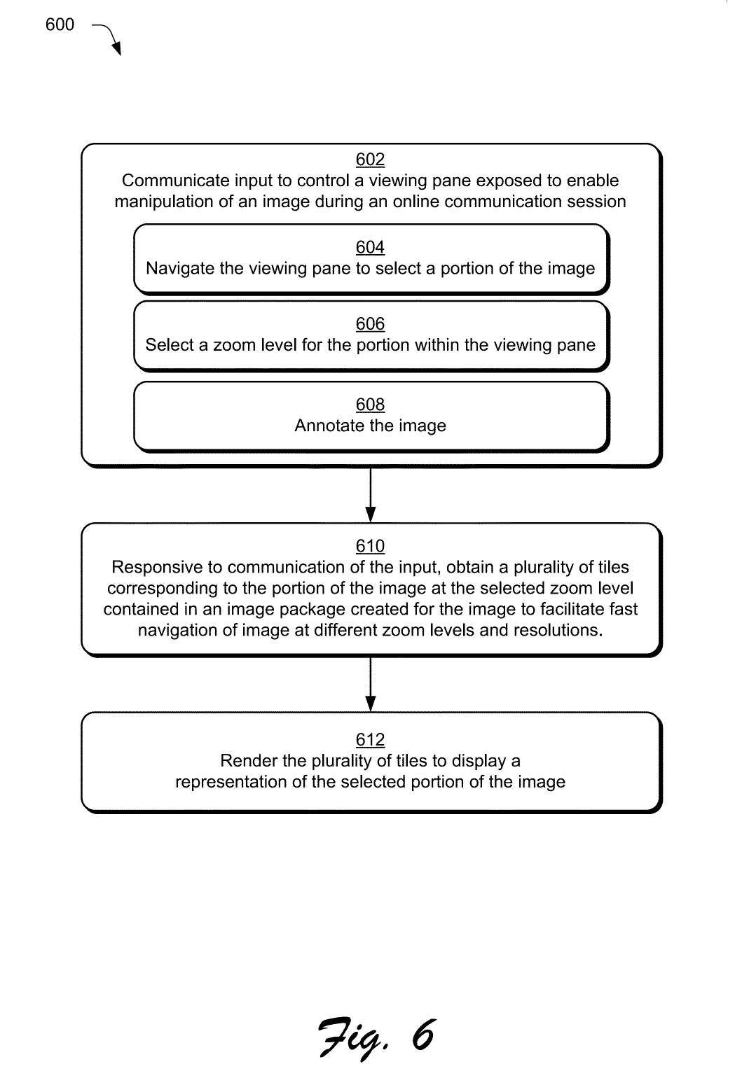

FIG. 6 is a flow diagram depicting an example procedure to manipulate an image via a viewing pane during an online communication session in accordance with one or more implementations. Input is communicated to control a viewing pane exposed to enable manipulation of an image during an online communication session (block 602). For example, clients involved in a communication session may provide input to manipulate the image in various ways described previously. In one or more implementations, each of the multiple clients involved in the communication may control a viewing pane 306 to manipulate a shared view 308 of the image and/or modify the shared view. In one approach, control may be passed selectively between clients. A presenter may be able to specify who has control over the image at a given time. Alternatively, multiple clients may be given joint control over the viewing pane by default or at the direction of a presenter. Thus, the viewing pane is controllable by each of the multiple clients involved in a communication session and a variety of input may be provided by various clients to navigate the image, selected various different views, and so forth.

By way of example and not limitation, the input may include input to navigate the viewing pane to select a portion of the image (block 604), select a zoom level for the portion within the viewing pane (block 606), and/or annotate the image (block 608) in various ways. Navigation of the viewing pane to pan and zoom an image may occur in the manner described herein including but not limited to the techniques discussed previously in relation to FIG. 3. Additionally, various kinds of annotations may be added to a shared image using a variety of techniques. For example, an annotation interface and/or one or more annotation tools may be provided by a user interface 124 in which a shared view is exposed. Annotations that may be applied to a shared image via the interface may include for example attaching, overlaying, or otherwise introducing text, shapes, highlights, flags, comments, callouts, audio, files and/or other types of annotations to portions of the shared image.

Responsive to communication of the input, a plurality of tiles are obtained that correspond to the portion of the image at the selected zoom level and are contained in an image package created for the image to facilitate fast navigation of the image at different zoom levels and resolutions (block 610). Then, the plurality of tiles is rendered to display a representation of the selected portion of the image (block 612). For example, appropriate tiles/versions to create a particular view may be identified from an image package 118 and communicated to participants in a communication session using techniques and components discussed throughout this document. Accordingly, clients involved in a communication session may obtain the tiles/versions that are communicated and output the corresponding view. In particular, a communication module 114 of a client may operate to receive data that is sufficient to form a particular view from the collaboration service 126 (or from a communication module 114 associated with another client in a peer-to-peer approach). The communication module 114 of the client may then render the tiles/versions that are obtained for display of a representation of a selected portion of the image, such as within a user interface 124 exposed for the communication session.

Having considered some example procedures, consider now a discussion of an example system and devices that may be employed to implement aspects of the techniques described herein in one or more implementations.

### Example System and Device

FIG. 7 illustrates an example system generally at 700 that includes an example computing device 702 that is representative of one or more computing systems and/or devices that may implement the various techniques described herein. The computing device 702 may be, for example, a server of a service provider, a device associated with the client (e.g., a client device), an on-chip system, and/or any other suitable computing device or computing system.

The example computing device 702 as illustrated includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage 712. The memory/storage 712 represents memory/storage capacity associated with one or more computer-readable media. The memory/storage 712 may include volatile media (such as random access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Thus, computer-readable storage media does not include signal bearing media or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to a signal-bearing medium that is configured to transmit instructions to the hardware of the computing device 702, such as via a network. Communication media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including applications 112, communication module 114, image processing module 116, collaboration service 126 and other program modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of modules as a module that is executable by the computing device 702 as software may be achieved at least partially in hardware, e.g., through use of computer-readable storage media and/or hardware elements 710 of the processing system. The instructions and/or functions may be executable/operable by one or more articles of manufacture (for example, one or more computing devices 702 and/or processing systems 704) to implement techniques, modules, and examples described herein.

As further illustrated in FIG. 7, the example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 702 may assume a variety of different configurations, such as for computer 714, mobile 716, and television 718 uses. Each of these configurations includes devices that may have generally different constructs and capabilities, and thus the computing device 702 may be configured according to one or more of the different device classes. For instance, the computing device 702 may be implemented as the computer 714 class of a device that includes a personal computer, desktop computer, a multi-screen computer, laptop computer, netbook, and so on.

The computing device 702 may also be implemented as the mobile 716 class of device that includes mobile devices, such as a mobile phone, portable music player, portable gaming device, a tablet computer, a multi-screen computer, and so on. The computing device 702 may also be implemented as the television 718 class of device that includes devices having or connected to generally larger screens in casual viewing environments. These devices include televisions, set-top boxes, gaming consoles, and so on.

The techniques described herein may be supported by these various configurations of the computing device 702 and are not limited to the specific examples of the techniques described herein. This is illustrated through inclusion of the image processing module 116 on the computing device 702. The functionality of the image processing module 116 and other modules may also be implemented all or in part through use of a distributed system, such as over a “cloud” 720 via a platform 722 as described below.

The cloud 720 includes and/or is representative of a platform 722 for resources 724. The platform 722 abstracts underlying functionality of hardware (e.g., servers) and software resources of the cloud 720. The resources 724 may include applications and/or data that can be utilized while computer processing is executed on servers that are remote from the computing device 702. Resources 724 can also include services provided over the Internet and/or through a subscriber network, such as a cellular or Wi-Fi network.

The platform 722 may abstract resources and functions to connect the computing device 702 with other computing devices. The platform 722 may also serve to abstract scaling of resources to provide a corresponding level of scale to encountered demand for the resources 724 that are implemented via the platform 722. Accordingly, in an interconnected device embodiment, implementation of functionality described herein may be distributed throughout the system 700. For example, the functionality may be implemented in part on the computing device 702 as well as via the platform 722 that abstracts the functionality of the cloud 720.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claimed subject matter.

What is claimed is:

1. A method implemented by a computing device comprising:
establishing a communication session between multiple clients;
determining an image to share during the communication session;
obtaining input indicative of navigation within the image from one of the clients to select a portion of the image with in a viewing pane viewable by the multiple clients in the communication session; and
communicating tiles representing the portion of the image that is selected for display by the multiple clients.

2. A method as described in claim 1, wherein the communication session comprises an online collaboration between the multiple clients established through a collaboration service provided by a service provider.

3. A method as described in claim 1, wherein the tiles are selected from an image package for the image that contains a collection of sub-images that correspond to the image.

4. A method as described in claim 3, wherein the collection of sub-images contained in the image package includes a plurality of versions of the image having different resolutions that are further divided into a plurality of tiles, the tiles that are communicated being selected from plurality of tiles contained in the image package to match the portion of the image that is selected.

5. A method as described in claim 1, wherein the viewing pane is configured to enable selection of a shared view of the image for rendering by the multiple clients during the communication session.

6. A method as described in claim 1, wherein the tiles communicated to represent the portion of the image collectively have less image data than image data for the image at full resolution thereby reducing an amount of data used to render a view of the portion of the image.

7. A method as described in claim 1, further comprising:
ascertaining a particular view of the image reflected by the input that is obtained, the particular view corresponding to a selected location and a selected zoom level; and
identifying the tiles for communication as tiles that match the particular view.

8. A method as described in claim 7, wherein identifying the tiles includes generating at least some tiles for the particular view on-demand during the communication session.

9. A method as described in claim 7, wherein identifying the tiles includes recognizing tiles that match the particular view in an image package constructed for the image according to metadata associated with the image package that describes a collection of sub-images corresponding to the image contained in the image package.

10. A computing device comprising:
a processing system; and
one or more modules that, when executed by the processing system, perform operations to facilitate image sharing during online collaborations including:
receiving an image selected for sharing during an online communication session between multiple clients;
pre-processing the image to produce an image package that includes multiple versions of the image at different resolutions and a plurality of tiles corresponding to portions of the image at the different resolutions; and
exposing the image package during the online communication session for selection of particular tiles contained in the image package that represent a portion of the image for a selected view.

11. The computing device of claim 10, wherein the pre-processing comprises producing the plurality of tiles according to a selected tile size that is a fraction of a full resolution for the image.

12. The computing device of claim 10, wherein the pre-processing comprises pre-computing the multiple versions of the image at different resolutions as a series of versions of the image between a full resolution of the image and a designated low level resolution.

13. The computing device of claim 10, wherein the image package is configured to arrange the multiple versions and plurality of tiles as a hierarchy of sub-images that may be selectively invoked to show different views of the image at varying levels of detail during the communication session.

14. The computing device of claim 13, wherein image package further includes metadata that describes the arrangement of the including the sizes and numbers of resolution versions, a tile size, and a number of tiles included for each of the resolution versions.

15. The computing device of claim 10, wherein the operations to facilitate image sharing further comprise outputting tiles that match a selected view of the image for rendering by the multiple clients at substantially the same time to implement a shared view of the image during the communication session.

16. The computing device of claim 10, wherein exposing the image package comprises storing the image package at a designated storage location accessible during the communication session to use the multiple versions and the plurality of tiles included in the image package.

17. One or more computer-readable storage media comprising instructions that, when executed by a client device, implement a communication module configured to perform operations comprising:
communicating input to control a viewing pane exposed to enable manipulation of an image during an online communication session with multiple clients;
responsive to communication of the input, obtaining a plurality of tiles corresponding to a selected portion of the image at a selected zoom level, the plurality of tiles contained in an image package created to facilitate fast navigation of the image at different zoom levels and resolutions during the online communication session; and
rendering the plurality of tiles to display a representation of the selected portion of the image.

18. One or more computer-readable storage media of claim 17, wherein the input to control the viewing pane includes input for one or more of: navigation of the viewing pane to select a portion of the image, selection of a zoom level for the portion within the viewing pane, or annotation of the image.

19. One or more computer-readable storage media of claim 17, wherein the communication module is configured to provide integrated functionality for user presence indications, video communications, online collaboration and meeting experiences, instant messaging, and voice calling.

20. One or more computer readable storage media of claim 17, wherein the viewing pane is controllable by each of the multiple clients involved in a communication session to manipulate a shared view of the image.
